(19) United States
(12) Patent Application Publication
(10) Pub. No.: US 2022/0158196 A1
(43) Pub. Date: May 19, 2022

(54) ELECTROCHEMICAL DEVICE SUCH AS A MICROBATTERY

(71) Applicant: COMMISSARIAT A L'ENERGIE ATOMIQUE ET AUX ENERGIES ALTERNATIVES, Paris (FR)

(72) Inventors: Arnaud BAZIN, Grenoble Cedex 09 (FR); Françoise GEFFRAYE, Grenoble Cedex 09 (FR); Sami OUKASSI, Grenoble Cedex 09 (FR); Séverine PONCET, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/454,498

(22) Filed: Nov. 11, 2021

(30) Foreign Application Priority Data
Nov. 13, 2020 (FR) 20 11643

(51) Int. Cl. H01M 4/66; H01M 10/04

(52) U.S. Cl. CPC H01M 4/661; H01M 10/0436

(57) ABSTRACT

An electrochemical device including, stacked successively on a face of a substrate, at least: a first current collector including at least one metal layer, a first electrode, an electrolyte, a second electrode. The first current collector includes a first portion covered by the first electrode and a second portion protruding laterally beyond the first electrode, and the electrolyte includes a surface covered by the second electrode. The second portion of the first collector extends under the electrolyte in a region of the electrolyte located outside the surface covered by the second electrode.

### TECHNICAL FIELD

The present invention relates to the field of electrochemical devices, having electrode and current collector portions, in the field of storing energy electrochemically.

The invention has for advantageous, but not limiting, application the manufacturing of microelectronic devices. The term microelectronic device means any type of device carried out with the means of microelectronics. These devices encompass in particular in addition to devices with a purely electronic purpose, micromechanical or electromechanical devices (MEMS, NEMS, etc.) as well as optical or optoelectronic devices (MOEMS, etc.).

A non-limiting specific interest of the invention is the production of electrochemical energy storage devices. This in particular includes devices of the solid electrolyte battery type, advantageously of small size, for example less than 20 (even less than 10) mm².

### PRIOR ART

A microbattery is an electrochemical device comprised of two electrodes (positive and negative) separated by an electrical insulator (the electrolyte).

The miniaturisation of nomad devices (connected objects, medical implants, etc.) entails being able to produce energy sources of small size (in particular a few mm²) capable of storing a sufficient quantity of energy. The capacity of a microbattery is directly proportional to the volume of the positive electrode.

In terms of electrical performance, the internal resistance of a microbattery is an essential factor that essentially depends on:
the electronic conductivity of the solid electrolyte;
the defectivity generated by the method of manufacturing;
the architecture of the microbattery.

In the particular case of microbatteries with a high cathode thickness (for example more than 10 μm), this involves:
an optimised electronic conductivity (often substantial electrolyte thickness, such as 3 μm at least);
an optimised defectivity of the method of manufacturing (reduction in holes in the form of a pin, in the roughness, in residues);
a restricted architecture (high filling rate, maximum superposition of layers).

A specific defect due to the architecture is observed and which substantially degrades the performance and the yield of microbatteries: the appearance, at the positive current collector, of metal needles at the edge of chips that cause short-circuits.

In terms of manufacturing electrochemical energy storage systems such as microbatteries, as shown in FIG. 1 showing a conventional microbattery stack, these stacks are generally carried out by successive depositions on a substrate 1 of a first current collector 2, of a first electrode 3, of an electrolyte 4 (or ionic conductor), of a second electrode 5, and of a second current collector 6. An encapsulation, through the deposition of additional layers, or via cover transfer, is often necessary to protect the system from the chemical reactivity with oxygen and water vapour. The collectors 2, 6 each have a portion for making contact, remaining accessible via the exterior of the microbattery for the electrical connection thereof, for example by using pads.

The migration of one or more ions between the two electrodes 3, 5 through the electrolyte 4 makes it possible to either store the energy or to deliver it to an external circuit.

FIG. 1 shows moreover the location where the defect can appear in the form of needles in the stack of layers thus manufactured. Indeed, in the zone marked 7, a growth phenomenon of metal elements is observed coming from a metal layer of the first collector 2 in a portion of the latter extending laterally in order to ensure a portion for making contact, in the form of needles. Passing through the electrolyte 4, such needles are able to create short-circuits between the first collector and the second electrode.

For example, document US 2019/0051944 A1 describes a method for manufacturing a stacked battery structure of which each battery layer comprises a battery element of the film type. However, the battery element disclosed in this document comprises regions where there are consecutively and in the stacking direction a current collector, an electrolyte and an electrode, which can cause short-circuits.

An object of the present invention is therefore to propose a solution to this problem of short-circuits, without penalising the efficiency of the architecture of the stack, in particular to retain the possibility of having a cathode volume and substantial contact surfaces between the stacked layers.

The other objects, characteristics and advantages of the present invention shall appear when examining the following description and accompanying drawings. It is understood that other advantages can be incorporated.

### SUMMARY

To achieve this objective, according to an embodiment an electrochemical device is provided comprising, stacked successively on a face of a substrate, at least:
a first current collector comprising at least one metal layer,
a first electrode,
an electrolyte,
a second electrode.

The first current collector comprises a first portion covered by the first electrode and a second portion protruding laterally beyond the first electrode, and

The electrolyte comprises a surface covered by the second electrode; possibly, the electrolyte comprises a flank portion extending in the stacking direction, a surface of the flank portion being covered by the second electrode.

The second portion of the first collector extends under the electrolyte in a region of the electrolyte located outside the surface of the electrolyte, which possibly includes a surface of the flank portion, covered by the second electrode.

The problems of short-circuits are thus resolved while still retaining an optimum exchange surface between the anode and the cathode. This is based on a microbattery architecture such that the first electrode (generally positive) covers the entire perimeter of the positive current collector, except on a zone for making contact. It is thus possible to arrange for the first collector to never be surmounted, according to the stacking direction, by the second electrode, with the electrolyte as the only interface. By preventing such a sandwich of the electrolyte by the first collector and the second electrode, the short-circuits are prevented.

Thus, most of the first current collector is predominantly insulated relatively to the rest of the stack, in such a way as to prevent short-circuits that can be due to raw needles from the first collector. A reduced portion of the first collector is used as a portion for making contact, that can be connected to the exterior, and is the object of a specific architecture of the stack at its location, in such way that the second electrode (and any other electrically conductive layers such as a second collector) does not surmount this portion of the first collector. If needles are formed, they will not have harmful consequences on the operation of the electrochemical device.

Another aspect relates to a method for manufacturing an electrochemical device, comprising a formation of a stack comprising in a stacking direction successively on a face of a substrate, at least:
a first current collector comprising at least one metal layer,
a first electrode,
an electrolyte,
a second electrode,
   wherein the first current collector comprises a first portion covered by the first electrode and a second portion protruding laterally beyond the first electrode, and wherein the electrolyte comprises a surface covered by the second electrode, characterised in that the formation of the second electrode comprises a deposition of a layer of second electrode, a masking of the definition of a non-masked region of the layer of second electrode, non-masked region wherein the second portion of the first collector extends under the electrolyte, and a removal of the layer of second electrode in the non-masked region, configured to form the second electrode on the electrolyte outside the non-masked region, in such a way that the second portion of the first collector is located outside the surface of the electrolyte covered by the second electrode. Recourse can thus be had to the techniques of photolithography of layer(s), and of etching of non-masked portions of such layer(s) in order to define the pattern of the second electrode.

Another aspect also relates to microbatteries that have the structure of the electrochemical device.

A method configured to manufacture such an electrochemical device is also presented.

### BRIEF DESCRIPTION OF THE FIGURES

The purposes and objects as well as the characteristics and advantages of the invention shall appear better in the detailed description of an embodiment of the latter which is shown in the following accompanying drawings wherein:

FIG. 1 shows an example of a stack of an electrochemical device according to the prior art.

FIG. 2 shows a cross-section view along the lines A-A of FIG. 4, showing an embodiment of the indicative invention.

FIG. 3 shows a cross-section view according to the lines B-B of FIG. 4, showing an embodiment of the indicative invention.

FIG. 4 shows a top view of an electrochemical device in an embodiment of the indicative invention.

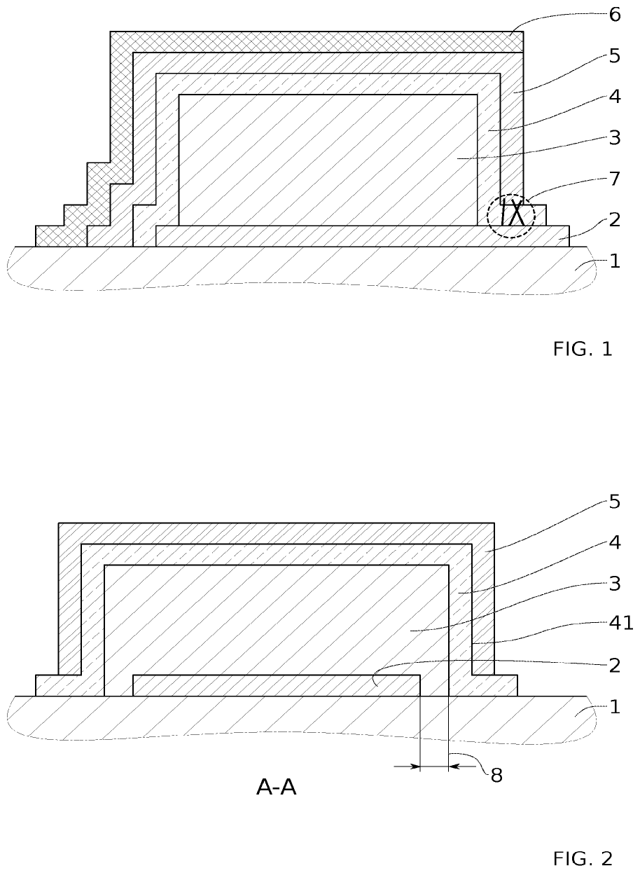

The drawings are given as examples and do not limit the invention. They form schematic block representations intended for facilitating the understanding of the invention and are not necessarily to scale of the practical applications. In particular the thicknesses are not necessarily representative of reality.

### DETAILED DESCRIPTION

Before beginning a detailed review of embodiments of the invention, optional characteristics are mentioned hereinafter that can possibly be used in combination or alternatively:
according to a possibility, the electrolyte 4 comprises a flank portion extending in the stacking direction and the region of the electrolyte located outside the covered surface of the electrolyte by the second electrode comprises a surface, referred to as the non-covered surface, of the flank portion;
possibly, the second electrode 5 comprises a covering portion of an upper face of the electrolyte 4, the covering portion being retracted relatively to an upper edge of a flank 31 of the first electrode 3, the flank 31 extending in the stacking direction; this retraction extends located in the continuity of the non-covered surface of the flank portion of the electrolyte 4;
the region of the electrolyte 4 located outside the surface covered by the second electrode 5 extends along the entire height, in the stacking direction, of the electrolyte 4;
the first portion of the first collector 2 is entirely covered by the first electrode 3.
the second portion 22 of the first collector 2 is a tab.
the first collector 2 comprises a layer of platinum.
the first collector 2 comprises a layer of titanium covered by the layer of platinum.
the surface of the flank portion covered by the second electrode 5 is of a surface area greater than 90% of the total surface area of the flank portion of the electrolyte 4.
globally, the non-covered surface of the electrolyte can represent less than 10% of the total surface thereof.

Preferably, the method of manufacturing is such that the masking is configured to further form a non-masked zone of an upper face of the electrolyte in the continuity of a portion of the non-masked region located at a flank of the electrolyte, the removal of the layer of the second electrode being configured to form a covering portion of the upper face of the electrolyte, with a retraction relatively to an edge of a flank of the first electrode.

It is stated that, in the framework of the present invention, the term “on” or “above” do not necessarily mean “in contact with”. Thus, for example, the deposition of a layer on another layer, does not necessarily mean that the two layers are directly in contact with one another but this means that one of layers covers at least partially the other by being, either directly in contact with it, or by being separated from it by a film, or yet another layer or another element. That said, the layers of the first collector, first electrode, electrolyte, second electrode and second collector are stacked preferably with successive contact surfaces.

A layer can moreover be composed of several sublayers of the same material or of different materials.

The term substrate, an element, a layer or other “with a base” of a material M means a substrate, an element, a layer comprising this material M only or this material M and possibly other materials, for example alloy elements, impurities or doping elements. Where applicable, the material M can have different stoichiometries.

It is stated that in the framework of the present invention, the thickness of a layer of the substrate is measured in a direction perpendicular to the surface according to which this layer or this substrate has its maximum extension. The stack of the electrochemical device is operated in this direction. A lateral direction extends as directed perpendicularly to the thickness of the substrate. In particular, the retraction that the second electrode has on the upper face of the electrolyte is advantageously directed in this lateral direction.

Certain portions of the device of the invention can have an electrical function. Some are used for electrical conduction properties and the terms electrode, collector or the equivalent means elements formed from at least one material having a sufficient electrical conductivity, in the application, to perform the desired function. Inversely, the terms electrical or dielectric insulator means a material that, in the application, provides an electrical insulation function.

According to the invention, as shown in FIGS. 2 to 4, a device is carried out comprising for the least, on a substrate 1 and under the electrolyte 4, a first current collector 2 and a first electrode 3.

In terms of the present application, the term collector means a portion of the device that has for function to connect an electrode to an element exterior to the device, i.e. located outside the stack of layers of the device, generally encapsulated. The term electrode means a portion of the device in electrical continuity with an active layer (in particular an electrolyte 4, more preferably solid, for the case of electrochemical storage). The current collector is connected to its electrode in such a way as to establish an electrical continuity between these two portions; the latter can furthermore come from one or more common layers of material; in this case, the collector will generally form a growth of the electrode, towards the outside of the encapsulated device. This growth can be narrower than the electrode itself, it can be a narrow conductive strip directed laterally relatively to the stack.

Generally, the invention comprises a stack of layers making it possible to carry out the various components of an electrochemical storage member. In this case, the stack itself comprises a first collector 2, a first electrode 3, an electrolyte 4 (carried out advantageously by a solid ionic conductor), a second electrode 5 and, generally, a second collector that is not shown in FIGS. 2 to 4. This second collector can follow exactly the same profile as the second electrode 5, with possibly an additional lateral portion at the substrate, that is generally the location of the making of contact.

The electrolyte 4 is a portion inserted between the two separated conductive portions constituted respectively of the first collector 2 and of the first electrode 3, and of the second electrode 5 and of the second collector. Ionic exchanges between these two conductive portions take place through the advantageously solid electrolyte, according to the principle of electrochemical energy storage.

The substrate is for example made of glass or silicon and can include an insulating surface layer if the base of the substrate is electrically conductive.

The first collector 2 comprises at least one metal layer, able to create needles. Preferably, the at least metal layer comprises a layer of titanium or with a titanium base. As a supplement, or alternatively, the at least one metal layer comprises a layer of platinum. Preferably, the first collector 2 comprises or consists of a successive stack of a layer of titanium surmounted by a layer of platinum. The thickness of the first collector can be greater than 200 μm and/or less than 350 μm.

As shown in FIG. 2, the first collector 2 includes a first portion that is entirely covered, including along its edge, by the first electrode 3. The dimension marked 8 corresponds to the minimum separation between the edge of the first portion of the first collector 2 and the internal surface of the electrolyte 4. It can be at least 1 μm, even at least 5 μm. Moreover, the first collector 2 comprises a second portion 22, preferably of a surface much more reduced than the first portion, and extending laterally towards the outside of the stack in order to allow for the making of electrical contact.

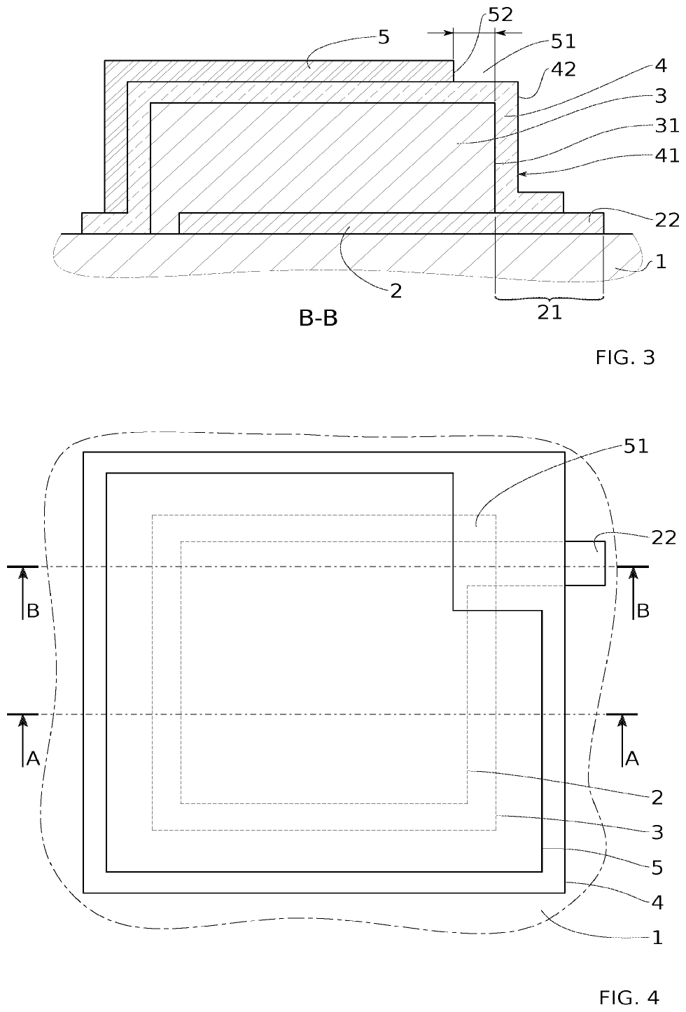

FIG. 3 shows this lateral protrusion of the portion 22, over a distance marked 21 relatively to the edge of the first electrode 3. This distance 21 is for example greater than 200 μm.

The portion 22, as can be seen from the top in FIG. 4, protrudes from the rest of the stack in order to be accessible via the outside. Preferably, an upper surface of this portion is exposed on the side of the stack, for a making of contact. This arrangement is reflected in FIG. 4. Thus, the second portion 22 of the first collector 2 can be a tab protruding laterally (for example by at least 50 μm) in order to be accessible beyond the stack. For example, the width of this tab can be greater than 50 μm and/or less than 200 μm.

The material of the first electrode 3 can be LICO but more preferably LiCoO2 (contraction of the term Lithium-Cobalt. Examples of materials are further given hereinafter that can also be used for the first electrode 3: V2O5, TiS2, LiMn2O4, NaMnO2, NaCoO2 . . .

The solid electrolyte 4 or a super-ionic material with a glass base are among the best candidates for the inorganic solid electrolytes applicable to any solid-state battery. A wide choice of sulphides and oxysulphide electrolyte vitreous systems have been developed, as well as a series of sulphide super-ionic glass-ceramic Li2S—P2S5, of which the ion conductivity of Li+ is comparable to that of liquid electrolytes. Regarding the electrolyte for sodium batteries, the same family of glass exists, for example Na3PS4.

The second electrode 5, typically the anode, can for example be made of silicon. The second collector that coves it preferentially can be made of copper or of titanium.

The first electrode 3 is preferably rather thick, for example at least 10 μm and predominantly covered by the active layer of electrolyte 8, in particular on the upper face of the first electrode 7 but also of the flanks thereof.

Consequently, the electrolyte 4 includes an upper face, surmounting the upper face of the first electrode 3 in the stacking direction, and a flank 41 that corresponds to a portion of the layer of electrolyte 4 covering an equivalent flank 31 of the first electrode 3. The flank 41 is directed, at least mostly, in the stacking direction. Preferably, and as shown in FIG. 2, the electrolyte 4 entirely surrounds the first electrode 3. In this way, the exchange surface is optimal.

Likewise, the second electrode 5 largely covers the electrolyte 4 on the upper face thereof, but also on its flank 41. Through this configuration, a lateral portion (or flank) of the second electrode 5 extends in the direction of the upper face of the substrate 1 to the extent that it could have contact there with the first current collector 2. In order to prevent such a situation, recourse is made to the particular arrangement shown in FIGS. 2 to 4.

As shown in FIG. 2, outside the zone of passage of the second portion 22 of the first collector 2, the electrolyte 4 has a flank 41 surface that is covered by the second electrode 5. Preferably, this covering descends to the foot of the layer of electrolyte 4, in such a way that the height of the electrolyte is entirely covered.

At the same time, in the zone of the stack in which the portion 22 of the first collector 2 extends laterally, the electrolyte 4 is not covered by the second electrode 5, in particular at the flank 41. Indeed, at this location, the second electrode 5 does not descend on the flank 41. in the example of FIG. 3, the second electrode 5 stops, at this location (in the zone where the portion 22 extends outside the portion covered by the first electrode 3), on the upper face of the electrolyte 4, without having a portion directed according to the thickness of the stack. Furthermore, as in the case shown, the edge 52 of the second electrode has therein a retraction 51 relatively to an upper edge of the flank 31 of the first electrode 3; in particular, the first electrode 3 preferably comprises an upper surface itself covered by the upper face of the electrolyte 4. The junction between the upper surface of the first electrode 3 and the flank 31 forms an edge with regards to which the edge 52 is retracted in the zone of the stack wherein the second portion 22 of the first collector 2 protrudes laterally, beyond the first electrode 3. Thus, the second electrode 5 does not surmount the second portion 22 of the second collector 2 even above the width of the flank portion of the electrolyte 4; in other words, the second electrode 5 does not extend on the upper face of the electrolyte 4 in a zone located to the right of the flank 31 and of the flank 42. For example, the retraction 51 can have a dimension of at least 5 μm in at least one direction in a plane perpendicular to the stacking direction, corresponding advantageously to the plane of the upper face of the electrolyte 4.

FIG. 4, a top view, reflects the combination of these two methods of covering operated by the second electrode 5. The second portion 22 of the first collector 2 has therein the form of a tab protruding from the first portion of the first collector, which here has a rectangular section, and more particularly square section.

Still in this example, the cathode forming the first electrode 3 encompasses the entire first collector 2, except in the portion of the second portion 22 forming a lateral protrusion. In this example, the section of the second electrode 3 is homothetic with that of the first portion of the first collector 2 (generally, this can be a rectangular, even square, section).

The electrolyte 4 travels the upper surface of the first electrode 3 by following the contour. As also shown in FIGS. 2 and 3, the electrolyte 4 also extends on the face of the substrate 1 that thus has an L-shape formed by its flank 41 and its foot bearing against the face of the substrate.

Except for the protruding nature of the second portion 22, the profile of these stacked layers is advantageously regular and the successive coverings are preferably integral.

It is a different matter for the second electrode 5. For the most part, the second electrode 5 covers the upper face and the flank 41 of the electrolyte 4 in such a way that a good portion of its surface surmounts the electrolyte 4. However, in the region of the passage of the second portion 22, the second electrode 5 forms a flaying in such a way that it does not cover the flank 41 of the electrolyte 4 or a zone of the upper face of the electrolyte 4. This clearance corresponds to the retraction zone 51.

The portion not covered by the second electrode 5 of the flank 41 extends to the right of the second portion 22 and, preferably, somewhat around, for example in order to cover a width of flank 41 of at least 1.5 times the width of the second portion 22.

In the case shown, the second portion 22 is formed by a single element, but this case is not limiting and the clearance in the second electrode 5 can be adapted consequently and according to the shape of the second portion 22.

Typically, for the deposition of the layers of the stack, it is possible to use a physical vapour deposition technique (PVD).

According to an example, the manufacturing chains the following steps:

A pattern of the first collector is first of all formed on the face of the substrate. The second collector can itself be deposited in one or more layers of one or more materials;

this can be an underlying layer of titanium covered with a layer of platinum. Preferably, these layers are planes.

The first electrode is deposited on the first collector 2. Preferably, the thickness thereof is more substantial.

Similarly, the electrolyte 4 is deposited. In light of the thickness of the first electrode 2, this deposition is configured to cover an upper portion and flank portion of the first electrode. Advantageously, a conformal deposition technique is used. The thickness is for example at least 3 μm.

Preferably, the formation of a layer of second electrode is then carried out. By masking, a pattern of the formation of the second electrode is then defined, by reserving a portion of the electrolyte 4 that will not be covered by this second electrode. The masking can cover a portion of the flank 41 of the electrolyte, and possibly an adjoining portion of the upper surface of the electrolyte. The thickness is for example at least 150 nm, possibly more than 200 nm and/or less than 500 nm. The non-masked portions will make it possible to define removal zones with the layer or layers of material intended for forming the second electrode.

Photolithography techniques can typically be used to define such a pattern. As hereinabove, the second electrode 5 can be carried out via a deposition. The removal can be done by conventional etching techniques.

As indicated hereinabove, other layers can surmount this assembly. In particular, a second collector can cover the second electrode. Care will then be taken that the zone of the electrolyte 4 left exposed by the second electrode 5 not be covered by the second collector.

The architecture thus constructed has the advantage, with respect to the known prior art, of minimising the risks of failures of the microbattery while still optimising the exchange surfaces between the active materials.

The microbatteries carried out according to this architecture have short-circuit rates less than 5%, compared to more than 70% before the change in architecture.

The invention is not limited to the embodiments described hereinabove and extends to all the embodiments covered by the invention.

1. An electrochemical device comprising, stacked successively on a face of a substrate in a stacking direction, at least:
a first current collector comprising at least one metal layer,
a first electrode,
an electrolyte,
a second electrode,
wherein the first current collector includes a first portion and of a second portion, the first portion being covered by the first electrode and the second portion protruding laterally beyond the first electrode, and
wherein the electrolyte comprises a surface covered by the second electrode,
wherein the second portion of the first collector extends under the electrolyte only in a region of the electrolyte located outside the surface of the electrolyte covered by the second electrode.

2. The device according to claim 1, wherein the electrolyte comprises a flank portion extending in the stacking direction, the region of the electrolyte located outside the covered surface of the electrolyte comprising a non-covered surface of the flank portion, wherein the second electrode comprises a covering portion of an upper face of the electrolyte, the covering portion being retracted relatively to an upper edge of a flank of the first electrode extending in the stacking direction in the continuity of the non-covered surface of the flank portion of the electrolyte.

3. The device according to claim 2, wherein the surface of the flank portion covered by the second electrode is of a surface area greater than 90% of the total surface area of the flank portion of the electrolyte.

4. The device according to claim 1, wherein the region of the electrolyte located outside the surface covered by the second electrode extends along the entire height, in the stacking direction, of the electrolyte.

5. The device according to claim 1, wherein the first portion of the first collector is entirely covered by the first electrode.

6. The device according to claim 1, wherein the second portion of the first collector is a tab.

7. The device according to claim 1, wherein the first collector comprises a layer of platinum.

8. The device according to claim 7, wherein the first collector comprises a layer of titanium covered by the layer of platinum.

9. A method for manufacturing an electrochemical device, comprising a formation of a stack successively comprising, in a stacking direction, on a face of a substrate, at least:
a first current collector comprising at least one metal layer,
a first electrode,
an electrolyte,
a second electrode,
wherein the first current collector includes a first portion covered by the first electrode and a second portion protruding laterally beyond the first electrode, and
wherein the electrolyte comprises a surface covered by the second electrode,
wherein the formation of the second electrode comprises a deposition of a layer of second electrode, a masking of the definition of a non-masked region of the layer of second electrode, non-masked region wherein the second portion of the first collector extends under the electrolyte, and a removal of the layer of second electrode in the non-masked region, configured to form the second electrode on the electrolyte outside the non-masked region, in such a way that the second portion of the first collector is located outside the surface of the electrolyte covered by the second electrode only.

10. The method according to claim 9, wherein the masking is configured to further form a non-masked zone of an upper face of the electrolyte in the continuity of a portion of the non-masked region located at a flank of the electrolyte, the removal of the layer of the second electrode being configured to form a covering portion of the upper face of the electrolyte, with a retraction relatively to an edge of a flank of the first electrode.
